(19) United States
(12) Patent Application Publication
(10) Pub. No.: US 2023/0028930 A1
(43) Pub. Date: Jan. 26, 2023

(54) SYSTEM AND METHOD FOR COMPUTING A DISTANCE-BASED RELATIVE DIRECTION

(71) Applicant: HISEP TECHNOLOGY LTD., YAVNE (IL)

(72) Inventors: GAD VERED, BE'ER YA'AKOV (IL); YARIV ERAD, KIDRON (IL); MENACHEM ERAD, ASHDOD (IL); URI VERED, RISHON LEZION (IL)

(21) Appl. No.: 17/520,673

(22) Filed: Nov. 7, 2021

Related U.S. Application Data
(60) Provisional application No. 63/221,957, filed on Jul. 15, 2021.

(51) Int. Cl. G01S 13/62; G01S 13/44; G01S 7/295

(52) U.S. Cl. CPC G01S 13/62; G01S 13/44; G01S 7/295

(57) ABSTRACT

A device and method for computing a relative direction to a Target, the device including a single antenna exchanging wireless signals with the Target, where the device moves from an initial position to additional positions, where in both positions the single antenna exchanges signals with the Target and the device measures distance-calculation-enabling properties of the wireless signal, where the device then estimates a distance to the Target based on the measured properties, where the device then computes a change in a distance between the DF electronic device and the Target according to the measured distance-calculation-enabling properties of the wireless signals in the initial position and the additional position, where the device then computes a relative direction of the Target from the DF electronic device's heading based on the change between the calculated distances and an associated changes in position of the DF electronic device.

### FIELD

The invention relates generally to computing a relative direction between electronic devices using a device having a single antenna, based on changes in the distance between the devices.

### BACKGROUND

In the recent year we have seen the integration of direction-finding elements in electronic devices such as smartphones. For example, both Apple and Samsung have integrated dedicated UWB antenna arrays in several of their smartphones models, to enable precise (or more accurate/more reliable) finding of “tags”—by showing to the user relative direction and distance from the phone to the tag.

Key here is that in order to enable such features, there is a need to use more than a single antenna for the DF. Meaning—the device manufacturer needs to allocate place in the phone for the antenna array, and verify that the design of the placement of the array and its interaction with other components of the phone will not negatively affect the DF performance—which can result in false relative direction.

Most DF techniques known in the art require the use of more than a single antenna.

In the event when a single antenna is used for DF, it has to be a directional antenna (i.e., a single antenna with directional radiation pattern, or use of an antenna array to create a directional radiation pattern), and the method of finding the direction of the target resembles the “cold/hot” game—the user rotates the DF, “pointing” the directional radiation pattern to different directions, monitor the measured signal strength based on the directional pattern—and associate the direction of the target with the direction in which the signal strength was the strongest.

This can also be achieved by have a mechanical mean rotating the antenna element, or by having beamforming means electronically rotating the antenna pattern. Yet—the principle is the same—the estimated direction of the target is associated with the direction in which the measured signal was the strongest.

Inherently, relaying on signal strength in these methods (while possible) is very unreliable, as it may fluctuate significantly, or if there are elements in the LOS between the DF and the Target.

Below is a short description of known DF techniques in the art.

There are many methods known for a Radio Frequency (RF) detector to find the direction of an RF source (Target), mainly using wave analysis methods. These methods can be generally categorized as Direction-Finding (DF) techniques and Monopulse techniques.

DF techniques can be categorized in groups—those which find the target's direction based on received signal amplitude, based on received signal phase, based on received signal timing etc. For the DF techniques described in general hereunder, the signal does not have to be modulated or bear any kind of information, and may be CW (Continuous Wave) or pulse.

Amplitude-based DF techniques use one or more antennas. An example of a single antenna DF is a rotational directional antenna. The direction, from which the Received Signal Strength (RSS) or Received Signal Strength Indication (RSSI) is the highest, is the expected direction of the target. In this technique, to get reliable results, the antenna is rotated without moving from its place to a different position.

Amplitude DF which uses several antennas (i.e., antenna array) measures the RSS/RSSI at each antenna and calculates the AOA (Angle of Arrival) of the signal using the amplitude differences.

Typical examples of amplitude DF that use several antennas are amplitude monopulse, Adcock, etc. Additional techniques assess the distance of the target, based on the signal strength, and by triangulating several measurements calculate the location of the target.

Phase-based DF techniques use two or more antennas (i.e., antenna array) and measure the phase difference of the arrival of a signal in the antennas and calculate from these phase differences the AOA of the signal.

This group includes for example interferometer DF, correlative interferometer DF, etc.

Time-based DF techniques are best known as TOA (Time of Arrival) kind of DF. They use two or more antennas (i.e., antenna array) and measure the time difference of the arrival of a signal in the antennas and calculate from these differences the signal's AOA. This group includes for example short and long base TOA, DTOA (Differential Time of Arrival) etc.

Monopulse DF techniques mainly used in ELINT (Electronic Intelligence) systems and radars, to find the direction from which a pulsed radar signal or echo is received. The signal is received in two or more directional antennas (i.e., antenna array). The signals in the antennas, usually highly directional antennas, are added in phase to compose a Sum or S signal and added in opposite phase to compose a Difference or D signal, in one or two dimensions, azimuth, elevation or both. Based on the S and D signal strengths, the direction of the target is found.

Another known technique in the art to conduct DF with a single antenna in the DF is known as “angle of departure” (or “AOD”). According to this technique it is possible to use a single antenna in the DF device—as long as one uses an antenna array for transmission in the Target, and the DF device obtains the layout of the antenna array. There is still a need to have an antenna array in the system

### SUMMARY

The invention, in embodiments thereof, relates to the use of a single antenna in a direction-finding (DF) device to determine the relative direction to a Target based on the changes in the distance between the DF device and the Target. In one aspect of the invention the use of a single antenna to determine the relative direction is described, based, for example, on Time-Of-Flight (TOF) distance estimations of wireless signals (such as RF but not limited to) exchanged between the DF device and the Target or on any other measurable property of the wireless signal which enables distance estimation calculation. The radiation pattern of the single antenna is irrelevant for the invention—i.e., can be omni-directional or any other radiation pattern. In one aspect of the invention a technique is described in which a DF device having a single antenna, is intentionally moved, and while doing so Movement Sensors in the DF device monitor the movement, device orientation, and device Heading. The movement of the DF device does not include mere rotation in place as done when using a directional single antenna. While moving, the DF conducts Wireless Communication with the Target, and based on properties of the exchanged signals calculates estimates distances to the Target, which are associated to logged movement data. By correlating between movement directions of the DF device, and increase/decrease in the estimated distance between the DF device to the Target in the initial position (i.e., the DF position before starting to move it) to additional positions, a relative direction to the Target can be determined. It should be clear that the invention is applicable to any frequency, protocol, wireless communication means and techniques.

In one aspect of the invention a direction-finding (DF) electronic device is configured to compute a relative direction to at least one Target, the DF electronic device including a single antenna configured to exchange wireless signals with the Target, a sensor module for sensing movement of the antenna, a processor configured to perform instructions. The instructions include, in an initial position of the DF electronic device, measuring distance-calculation-enabling properties of the wireless signal exchanged between the DF electronic device and the Target, and computing an initial distance estimation between the DF electronic device to the Target based on said distance-calculation-enabling properties, in at least one additional position of the DF electronic device, measuring distance-calculation-enabling properties of the wireless signal exchanged between the DF electronic device and the Target, and computing a distance estimation between the DF electronic device to the Target for the additional position based on said distance-calculation-enabling properties, measuring the movement of the DF electronic device from the initial position to the at least one additional position in regard to the DF electronic device's heading, computing a change in a distance between the DF electronic device and the Target according to the measured distance-calculation-enabling properties of the initial wireless signal versus the second wireless signal, computing a relative direction of the Target from the DF electronic device's heading based on the change between the calculated distances and an associated changes in position of the DF electronic device.

In some cases, the single antenna is an omni-directional antenna. In some cases, the single antenna is a directional antenna.

In some cases, the device further includes an indicator for indicating the relative direction of the Target. In some cases, the indication is computed relative to the heading of the DF electronic device. In some cases, the indication is selected from “forward”, “rearward”, “right”, “left” and a combination thereof. In some cases, the indication is provided in the form selected from display, audio, illumination and a combination thereof.

In some cases, the instructions include generating a message to a user of the DF electronic device to move the DF electronic device. In some cases, the instructions include generating a movement indication for indicating to a user of the DF electronic device a feedback on the required movement of the DF electronic device.

In some cases, the instructions include generating a movement indication for indicating to a user of the DF electronic device a stage of the movement of the DF electronic device. In some cases, the instructions include generating a movement indication for indicating to a user of the DF electronic device a time left to complete a movement of the DF electronic device.

In some cases, the movement includes a horizontal movement component. In some cases, the DF electronic device is integrated in a smartphone. In some cases, the DF electronic device is integrated in a wearable electronic device. In some cases, the distance-calculation-enabling properties include time-of-flight properties.

In one aspect of the invention a direction-finding (DF) electronic device is configured to compute a relative direction to at least one Target, the DF electronic device including a single antenna configured to exchange wireless signals with the Target, an output module for outputting messages to a user of the DF electronic device, the messages include guidance on how to move the DF electronic device, a processor configured to perform instructions, the instructions including, in an initial position of the DF electronic device, measuring distance-calculation-enabling properties of the wireless signal exchanged between the DF electronic device and the Target, and computing an initial distance estimation between the DF electronic device to the Target based on said distance-calculation-enabling properties, outputting an instruction to move the DF electronic device to a predefined additional position relative to the initial position and to the DF device heading, receiving an indication that the DF electronic device is in the predefined additional position, in at least one predefined additional position of the DF electronic device, measuring distance-calculation-enabling properties of the wireless signal exchanged between the DF electronic device and the Target, and computing a distance estimation between the DF electronic device to the Target for the predefined additional position based on said distance-calculation-enabling properties, computing a change in a distance between the DF electronic device and the Target according to the measured distance-calculation-enabling properties of the initial wireless signal versus the second wireless signal, computing a relative direction of the Target from the DF electronic device based on the change between the calculated distances and an associated changes in position of the DF electronic device.

In some cases, the single antenna is an omni-directional antenna. In some cases, the single antenna is a directional antenna. In some cases, the device further includes an indicator for indicating the relative direction of the Target. In some cases, the movement includes a horizontal movement component. In some cases, the DF electronic device is integrated in a smartphone. In some cases, the DF electronic device is integrated in a wearable electronic device. In some cases, the distance-calculation-enabling properties include time-of-flight properties.

In one aspect of the invention a method is provided for computing a relative direction from a DF electronic device to at least one Target, the method including, in an initial position of the DF electronic device, measuring distance-calculation-enabling properties of wireless signal exchanged between the DF electronic device and the Target, and computing an initial distance estimation between the DF electronic device to the Target based on said distance-calculation-enabling properties, in at least one additional position of the DF electronic device, measuring distance-calculation-enabling properties of the wireless signal exchanged between the DF electronic device and the Target, and computing a distance estimation between the DF electronic device to the Target for the additional position based on said distance-calculation-enabling properties, measuring the movement of the DF electronic device from the initial position to the at least one additional position in regard to the DF electronic device's heading, computing a change in a distance between the DF electronic device and the Target according to the measured distance-calculation-enabling properties of the initial wireless signal versus the second wireless signal, computing a relative direction of the Target from the DF electronic device's heading based on the change between the calculated distances and an associated changes in position of the DF electronic device.

In some cases, the single antenna is an omni-directional antenna. In some cases, the single antenna is a directional antenna. In some cases, the method further includes outputting an indication for indicating the relative direction of the Target. In some cases, the movement includes a horizontal movement component. In some cases, the DF electronic device is integrated in a smartphone. In some cases, the DF electronic device is integrated in a wearable electronic device. In some cases, the distance-calculation-enabling properties include time-of-flight properties.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a DF electronic device and a Target, both having a single antenna, according to an exemplary embodiment of the invention;

FIG. 2 shows a DF electronic device having a single antenna, according to an exemplary embodiment of the invention;

FIG. 3 shows a Target device having a single antenna, according to an exemplary embodiment of the invention;

FIGS. 4A-4B show a DF electronic device moving relative to a Target device when the Target device is in the general direction of the DF device's heading, according to an exemplary embodiment of the invention;

FIGS. 5A-5B show a DF electronic device moving relative to a Target device when the Target device is in the opposite direction from the DF device's heading, according to an exemplary embodiment of the invention;

FIG. 6 shows a DF electronic device moving in an arc-like shape relative to a Target device, according to an exemplary embodiment of the invention; and

FIGS. 7A and 7B, taken together, shows a method for determining a relative location of a Target from the heading of a DF electronic device, according to an exemplary embodiment of the invention.

### DETAILED DESCRIPTION

The invention, in embodiments thereof, relates to the use of a single antenna in a direction-finding (DF) device to determine the relative direction to a Target. In one aspect of the invention the use of a single antenna to determine the relative direction is described, based on distance estimations calculated from properties of the wireless signals (such as RF) exchanged between the DF device and the Target, such as, but not limited to, Time-Of-Flight (TOF). In one aspect of the invention a technique is described in which a DF device having a single antenna, is intentionally moved, and while doing so Movement Sensors in the DF device monitor the movement, device orientation, and device Heading. While moving, the DF conducts Wireless communication with the Target, and based on properties of the exchanged signals calculates estimated distances to the Target, which are associated to logged movement data in such manner that the initial distance from the initial position (i.e., before moving the DF device) is compared to one or more distances from one or more additional positions after moving the DF device from the initial position. By correlating between movement directions of the DF device from the initial position, and increase/decrease in the estimated distance between the DF device to the Target, a relative direction to the Target can be determined. It should be clear that the invention is applicable to any frequency, protocol, wireless communication means and techniques.

In one embodiment of the invention a method is provided to determine the relative direction from a DF electronic device to a target, wherein the DF electronic device comprises a single antenna. The method includes conducting wireless communication between the DF electronic device and at least one Target in an initial position, via the single antenna and measuring at the DF electronic device the Time of Flight (TOF) to the target (either by one-way from the Target to the DF electronic device or by TWR). the method then discloses estimating the distance between the DF electronic device and the Target in several additional positions of the DF electronic device. For each distance calculation, the method discloses associating the Heading of the DF electronic device and data from the movement sensor. The association can also be made not for each position but based on predefined time interval periods. then, the method discloses moving the DF electronic device in such manner that the DF device moves in space from its previous position. Then, the method discloses logging such movement with the movement sensor and measuring TOF and calculating the distance. Then, the method discloses determining the relative direction from the DF to the Target based on the changes in the calculated distance in the initial position versus each additional positions and the Heading of the DF.

For example, a user may hold a smartphone with the DF inside, in such orientation that the “top” of the phone, defined as the “Heading” points away from the user. Initial distance measurement at the initial position may estimate the distance to the Target at 3 m. When the user moves the DF forward (either by walking or moving the phone forward—“away” from his body) —the calculated estimated distance may change to 3.3 m. Using the movement sensor that monitors the movement of the DF in relation to the DF device's Heading—i.e., determine that the DF is “moving forward” in relation to the Heading. This means that the movement caused the DF to move away from the Target, and therefore implies that the Target is behind the user. If the calculated estimated distance was decreased—i.e. changed from 3 m to 2.7 m—than by obtaining the movement direction in relation to the Heading would imply that the DF device moves towards the Target—therefore the Target is IN-FRONT of the user.

In one embodiment of the invention a system is provided including at least one DF electronic device having a single antenna used for the DF process and at least one Target having a single antenna used for the DF process. The antennas of each device may be omni-directional antennas or directional antennas. The antennas may be any type of antennas.

In one embodiment of the invention an exemplary method is provided to determine the relative direction, in which the user freely moves the DF device in various directions, not only forward/backwards. For example, in a horizontal arc movement. Moving the DF device in such manner means that the DF device moves in two planes vs the Target. By logging the DF device's movement using the Movement Sensors, associating the movements to the Heading, and associating the calculated estimated distance to the DF movement, the relative direction of the Target can be determined.

For example, the user may hold a phone having a DF module inside, and swing or move the phone in a horizontal arc from left to right, while holding the phone in a natural holding so the Heading (i.e., the “upper” side of the phone) points away from the user. If the starting point of the movement is at 270 degrees from the user's front side, then when the phone will be “Front” it will be in 0 degrees, and when the phone is at the “ending” point of the arc the heading is at 90 degrees, assuming that the Target is in front of the user. As the DF device moves, TOF is measured and distance is calculated. So, if the distance at the starting point was calculated at 3 m, and while moving towards the 0 degrees point distance is calculated to be decreasing until (for example) 2.7 m at 0 degrees—and as the DF keeps its movement towards the 90 degrees—the distance will start to increase as the DF device moves away from the Target.

By detecting the point in the movement in which the distance changed from decreasing to increasing, and knowing the Heading of the DF device and the initial position—an indication can be provided to the user regarding the relative direction of the Target.

The same method may apply if the Target is behind the user. In such case the estimated distance at the starting point will be 3 m, and the movement in the arc towards the 0 degrees point the distance will increase (until for example 3.3 m), and as the arc movement continues towards the 90 degrees—the distance will decrease.

In some cases, the DF electronic device may comprise indication means to provide relative direction indications. The indication means may comprise a display, audio, lights, and any other forms of indication. In some cases, the DF electronic device may include a graphical user interface (GUI).

The methods disclosed herein may be executed by having the user move (i.e., walk), or by having the user move or swing the DF electronic device—but not move from his place (i.e., moving his hand when the DF is in his smartwatch).

The methods disclosed herein may utilize means to provide movement information, informing the user that he needs to move the DF electronic device. The movement information may describe a preferred movement type for the user. The movement information may include real-time (or real-near time) indication to the user about the quality of his/her movement and/or stage of the movement and/or time left to complete the movement.

The methods disclosed herein are not limited to smartphones, and can be applied to any device that can perform such movement—for example (but not limited to) smart watches, glasses, smart rings, tablets, gaming consoles, electronic devices, drones, vehicles, etc. in some cases, the DF device may include at least one processor, at least one display device, at least one movement Sensor, at least one antenna used for DF, at least one power source, such as a battery, at least one Tilt Sensor, at least one audio indication means and at least one haptic indication means.

The term “Initial Position” refers to the starting point and position is space from which the DF device is being moved during the DF process. The initial position may define the point in space from which the Movement Sensors starts to monitor the movement of the DF device in relation to its Heading during the DF process. The initial position may define the point in space when the device starts to output instructions to the user for moving the DF device.

The term “Additional Positions” refers to points in space whereto the DF device is moved during the DF process. Said Additional Positions are relative to the Initial Position.

The term “Time-of-Flight or TOF or TOA” refers to the measurement of the time taken by an object, particle or wave (be it acoustic, electromagnetic, light etc.) to wirelessly travel a distance through a medium. It also refers to the absolute time of arrival at a DF device or to the measured time difference between departing from a Target and arriving at the DF device. The distance/path length between a DF device and a Target can be directly calculated from the time of arrival as Wireless Communication wave travel with a known velocity.

The term “Round Trip Time or RTT or TWR” refers to the length of time it takes for a signal to be wirelessly sent plus the length of time it takes for an acknowledgement of that signal to be received. This time includes propagation time for the paths between the Target and a DF device. This information can then be used to measure velocity or path length. TOA or TOF can be applied to calculate the RTT and distance.

The term “Line-of-sight or LOS”—refers to the characteristic of electromagnetic radiation propagation (including RF and light) or acoustic propagation which means waves travel in a direct path from a Target to a DF device.

The term “None-Line-of-Sight or near-LOS, or NLOS” refers to events in which the rays or waves may be delayed due to the presence delaying material in the direct path (in whole or in part of the path) of the wireless communication between the Target and the DF device

The term “Wireless Communication” refers to the transfer of information and/or data (of all kinds, such as—but not limited to voice, image, video, laser, Analog or digital and/or packets (formatted blocks of data) and/or communication acknowledgment/no-acknowledgment and/or voice over long or short distances without the use of electrical conductors or “wires” but via Radio waves and/or light waves and/or sound waves, at any given frequency.

The term “Wireless Communication Protocol and/or Standard” refers to any protocol and/or standard used to conduct Radio and/or light and/or sound Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”. (It should be clearly stated that among such protocols, but not limited only to them, are Wi-Fi, Bluetooth, Low-Energy-Bluetooth (BLE), Wi-Max, ZigBee, Z-wave, Insteon, UWB, Cellular devices communication protocols, Near-field Communication (NFC), RFID protocols or standards). Shall also refer to the use of such protocols over any radio frequency, such as—but not limited to, UHF, HF, VHF, 2.4 Ghz, 5 Ghz, 18 Ghz, 60 Ghz UWB-dedicated frequencies, and up to 300 Ghz.

The term “Antenna Module or Antenna Array, or AM” refers to a system and/or a device comprising at least one antenna that can be used to either transmit and or receive radio signals in pre-defined antenna pattern.

The term “Direction finder or DF device or Looker” refers to a device and/or object and/or thing having Wireless Communication means (such as, but not limited to, IOT) with using a single antenna to determine the relative direction to a Target as defined herein under. Alternatively, the device is used to find whether one or more Targets are located within a desired direction from the finder. Said DF can be a stand-alone device or integrated into another electronic device, either via software or hardware or a combination of both. A DF device can also function as a Target. Said DF device may include a compass component and/or Accelerometer and/or Gyro and/or Tilt sensors and/or an AM.

The term “Target” refers to a device and/or object and/or thing having Wireless Communication means (such as, but not limited to, IOT), or an RF communication source, which comprises RF transmitter and/or receiver and/or repeater or transponder and/or tag, which communicates wirelessly directly (i.e., not via relays) with the DF, and which also comprises an AM. A Target device can also function as a DF device. Said Target may include a compass component and/or Accelerometer and/or Gyro and/or Tilt sensors.

The term “Communication Circuit” or in short “Comm” refers to an RF and/or light and/or sound transmitter and/or receiver which communicates wirelessly with one or more Targets. The Comm. may be (but not limited to) Wi-Fi, Bluetooth, ZigBee, UWB, and RFID etc. at any frequency.

The term “Identification Data or ID” refers to a number, either serial or other, a name, a collection of symbols, or any other type of reference used to provide an electronic device a unique identification, which enables users and/or systems to identify, track, monitor, and operate the device. Said ID may be originally provided by the devices manufacturers, may be assigned to it by a computer system, may be assigned by a user, or may be used simply to associate a unique description by a user to the device. A device may also have more than one IDs attached to it (for example, by the manufacturers, by the system, and by the user). A device may also broadcast different ID at different statuses (for example, ID1 for “stand-by”, ID2 for “operating”).

The term “Target Compass Azimuth, or Target AZ” refers to compass bearings that are stated in the Target's system in which either north or south can be the zero, and the angle may be measured clockwise or anticlockwise from the zero.

The term “DF device Compass Azimuth, or DF device AZ” refers to compass bearings that are stated in the DF device's system in which either north or south can be the zero, and the angle may be measured clockwise or anticlockwise from the zero.

The term “Heading” refers to a virtual pre-determined direction, in relation to a physical heading” of the AM, and will be used to illustrate the “Heading” Target or DF device. Said Heading can correlate with a device's display shape or position.

The term “AZ” refers to Azimuth with respect to the north. Range: 0úAZ<360.

The term “f” refers to Direction with respect to the Heading (either the DF device's Heading or the Target's Heading). Range: −180úf<180

The term “Internet-of-Things or IOT” refers to physical objects or “things” embedded with electronics, software and/or sensors and Wireless P2P Communication connectivity to enable it to connect with other devices. Each thing is locally uniquely identifiable through its embedded computing system but is might be able to interoperate within the existing Internet infrastructure. Such thing does not have to include a display mean.

The term “Peer-2-peer or P2P” refers to a Wireless Communication network between at least 2 wireless devices, which allows wireless devices to directly communicate with each other. Said Wireless devices within range of each other can discover and communicate directly without involving central access points. This term also covers the use of Wireless Communication between a cellular device to a Base-station, Base-station to Cellular device, and Base-Station to Base-station. It also covers, in the same manner, TV stations Wireless Communication.

The term “Accelerometer” refers to a device that measures proper acceleration—i.e., the acceleration experienced relative to freefall. Single- and multi-axis models are available to detect magnitude and direction of the acceleration as a vector quantity, and can be used to sense position, vibration and shock. Said accelerometer can be a component and/or sensor in portable electronic devices—such as, but not limited to, cellular phone, video game controllers/console, digital camera, GPS device, media player, laptop computer, tablet computer, wireless remote control, PDA—to detect the position of the device or provide for game input.

The term “Gyroscope” refers to a device for measuring or maintaining orientation, based on the principles of conservation of angular momentum. Said Gyroscope can be a component and/or sensor in portable electronic devices—such as, but not limited to, cellular phone, video game controllers/console, digital camera, GPS device, media player, laptop computer, tablet computer, wireless remote control, PDA—to detect the position of the device or provide for game input.

The term “Tilt sensor”—refers to device and/or component that can measure the tilting in often two axes of a reference plane in two axes, in portable electronic devices—such as, but not limited to, cellular phone, video game controllers/console, digital camera, GPS device, media player, laptop computer, tablet computer, wireless remote control, PDA—to detect the position of the device or provide for game input.

The term “Cross Verification” refer to a mode of operation of the system, in which the Target and DF devices can each change functionality—i.e., Target & Looker and Looker & Target, and when doing so can switch between the Reversed DF method to prior-art DF methods.

The term “Movement Sensor” shall refer to components and/or sensors and/or combination of in an electronic device (such as, but limited to, accelerometer, gyroscope, camera) capable of monitoring the movement of the electronic device in space, from one physical position to another, in regard to the electronic device's Heading. Movement Sensors may include Tilt Sensors.

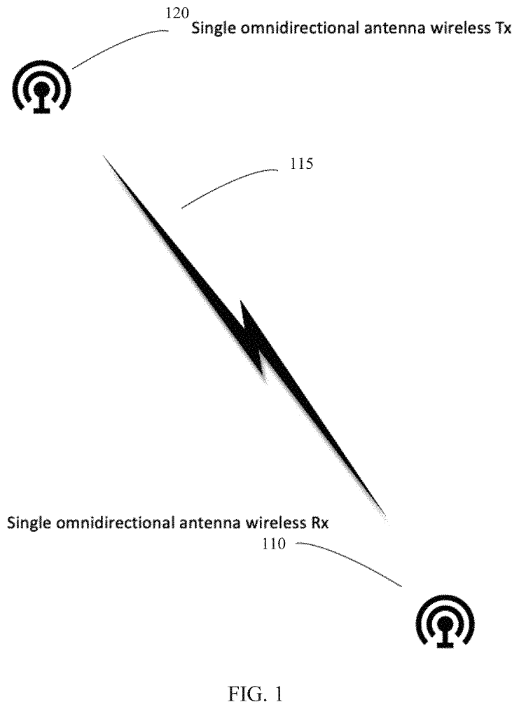

FIG. 1 shows a DF electronic device and a Target, both having a single antenna, according to an exemplary embodiment of the invention. The DF electronic device 110 and the Target 120 exchange electronic signals over a wireless network. The electronic signals enable measuring distance-calculation-enabling properties, such as time of flight (TOF), indicating a time duration elapsing between transmission timestamp and receiving timestamp of a signal exchanged between the DF electronic device 110 and the Target 120. Exchanging includes transmission from the DF electronic device 110 and transmission from the Target 120.

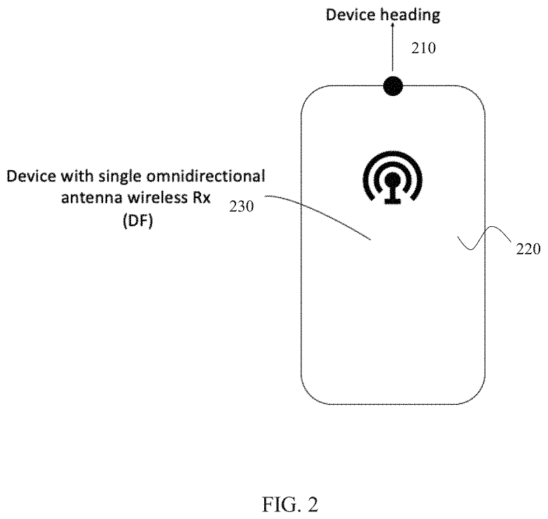

FIG. 2 shows a DF electronic device having a single antenna, according to an exemplary embodiment of the invention. The DF electronic device 230 may comprise a housing for protecting the electrical circuitry therein, a memory for storing instructions and additional information, and a processor for executing the instructions used to perform the methods described herein. The DF electronic device 230 comprises a single antenna 220 configured to exchange wireless electronic signals with another device. The wireless electronic signals may be Wireless communication, and/or in any Wireless Communication Protocol, and/or in a format and type desired by a person skilled in the art. The DF electronic device 230 has a heading 210. The heading 210 may be defined by a user, or by a computer software that provides an indication as to the relative direction of the Target from the DF electronic device 230. In some cases, the heading 210 may be in the upper end of the DF electronic device 230. The upper end of a cellular phone may be defined one of the edges of a surface to which the display is coupled.

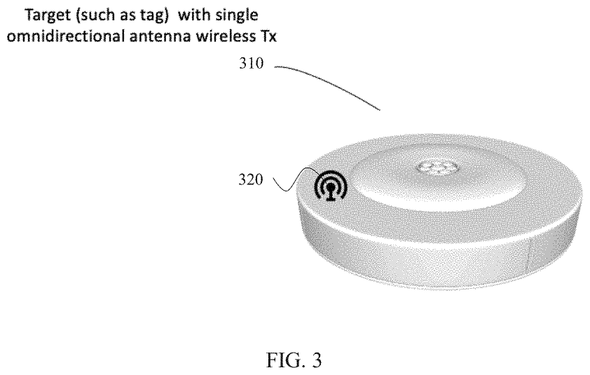

FIG. 3 shows a Target device having a single antenna, according to an exemplary embodiment of the invention. The Target device 310 may be a mobile personal electronic device, such as a cellular phone, tablet computer and the like. The Target device 310 may be a tag placed in a specific location, for example coupled to an entrance to a building, coupled to a vehicle, and the like. The Target device 310 comprises a power source such as a battery, or a coupling to the electrical grid. The Target device 310 comprises a single antenna 320 for exchanging signals with other devices. For example, the antenna 320 may exchange signals with one or more DF electronic devices.

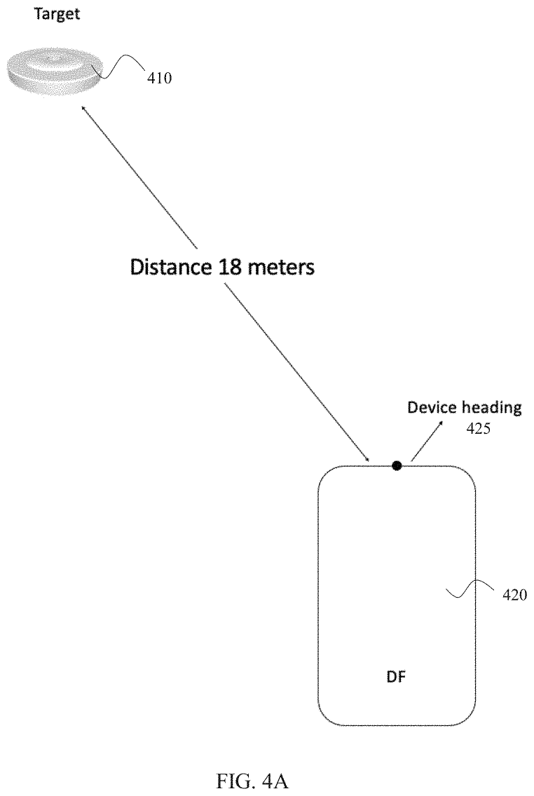

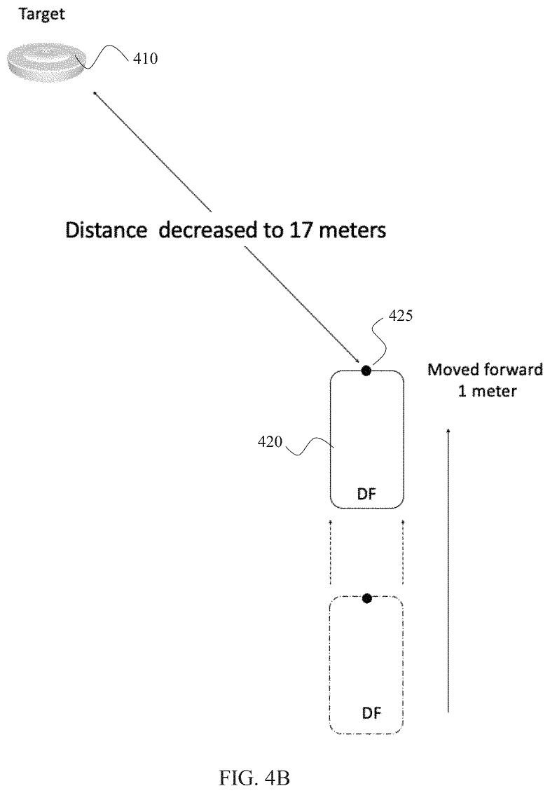

FIGS. 4A-4B show a DF electronic device moving relative to a Target device when the Target device is in the general direction of the DF device's heading, according to an exemplary embodiment of the invention. FIG. 4A shows the DF electronic device 420 in an initial position, exchanging signals with Target device 410, aiming to determine an initial distance of the Target 410 from the heading 425 of the DF electronic device 420. Then, as shown in FIG. 4B, the DF electronic device 420 is moved by a user of the DF electronic device 420. The movement is in the direction of the heading 425.

After the movement, and in some cases also during the movement, of the DF electronic device 420, the DF electronic device 420 and the target device 410 again exchange signals. The processor of the DF electronic device 420 computes an estimated distance between the DF electronic device 420 and the target device 410 both in the initial position shown in FIG. 4A and in the second position shown in FIG. 4B. As the distance in the second position in smaller than the distance in the initial position, the consequence is that the target device 410 is in the general direction of the heading 425.

The DF electronic device 420 comprises a movement sensor for sensing movement of the DF electronic device 420. The DF electronic device 420 may comprise an indication module for outputting an indication as to the relative direction of the Target device 410, for example a display, audio signals via a speaker, vibrating indication and the like. The DF electronic device 420 may comprise an output module for outputting instructions and/or commands to the user of the DF electronic device 420, for example “move the device to the right”.

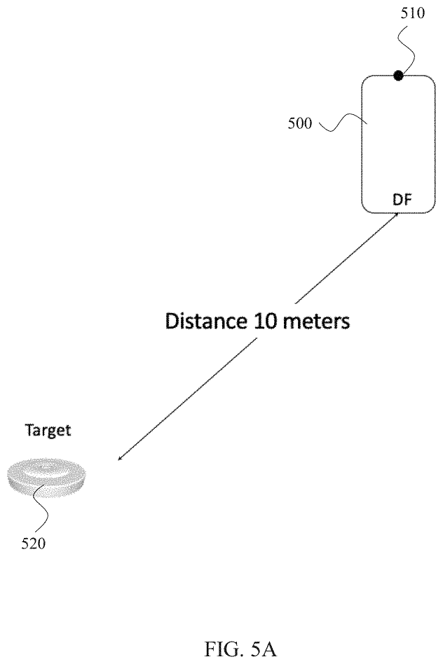

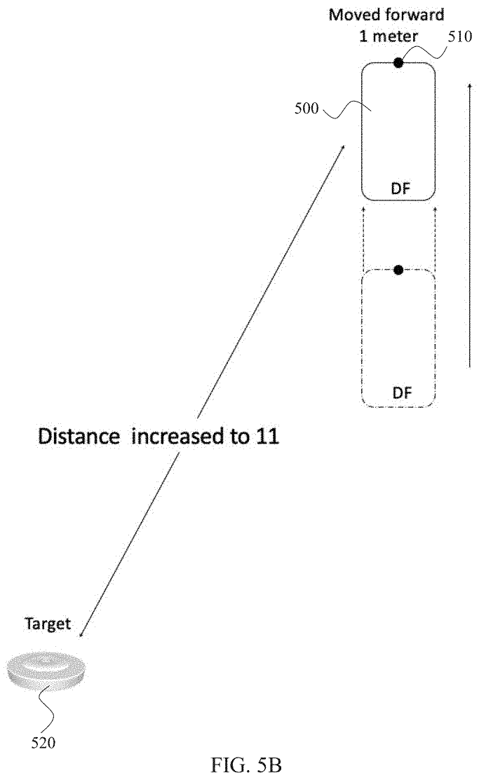

FIGS. 5A-5B show a DF electronic device moving relative to a Target device when the Target device is in the opposite direction from the DF device's heading, according to an exemplary embodiment of the invention.

FIG. 5A shows the DF electronic device 500 in an initial position, exchanging signals with Target device 520, aiming to determine an initial distance of the Target 520 from the heading 510 of the DF electronic device 500. Then, as shown in FIG. 5B, the DF electronic device 500 is moved by a user of the DF electronic device 500. The movement is in the direction of the heading 510.

After the movement, and in some cases also during the movement, of the DF electronic device 500, the DF electronic device 500 and the target device 520 again exchange signals. The processor of the DF electronic device 500 computes an estimated distance between the DF electronic device 500 and the target device 520 both in the initial position shown in FIG. 5A and in the second position shown in FIG. 5B. As the distance in the second position in higher than the distance in the initial position, the consequence is that the target device 410 is in the general opposite direction of the heading 425.

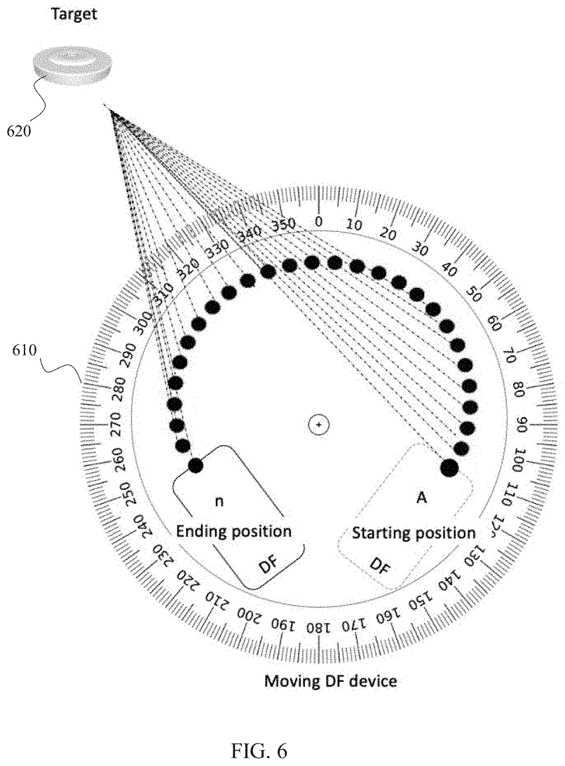

FIG. 6 shows a DF electronic device moving in an arc-like shape relative to a Target device, according to an exemplary embodiment of the invention. The DF electronic device 610 moves in an arc-like shape or another form of a rotational movement relative to the target device 620. This way, the target device's relative direction from the heading of the DF electronic device 610 changes over time, during the movement. For example, at first, when the electronic device was heading at 110 degrees, the distance measurements were high, and as the DF electronic device 610 moves counter clockwise towards the ending position, the distance decreases, meaning that the relative direction of the target device 620 is closer to the heading of the DF electronic device. It should be clear that the arc-like movement is only one possible way to move the DF electronic device, and the invention covers any other possible movement, including un-structured ones.

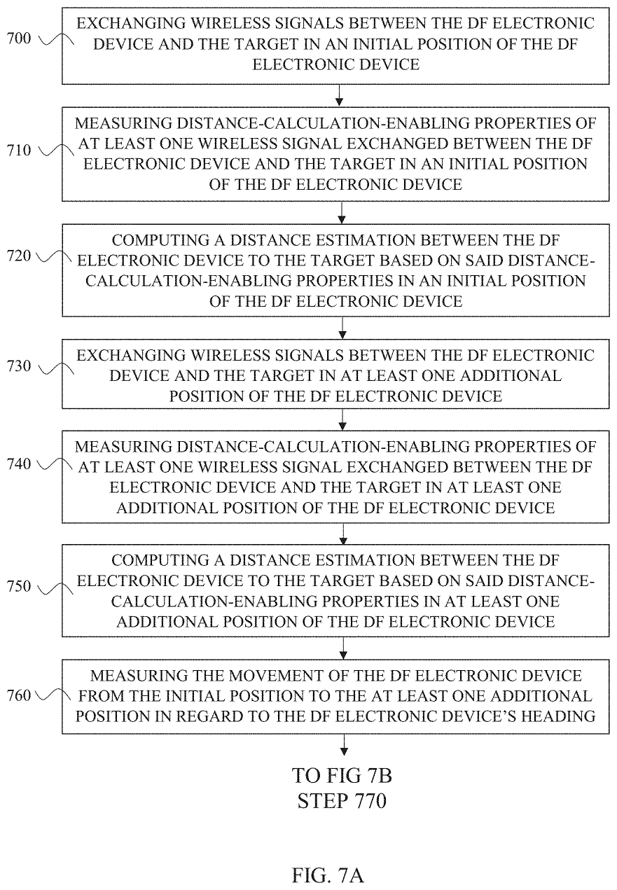

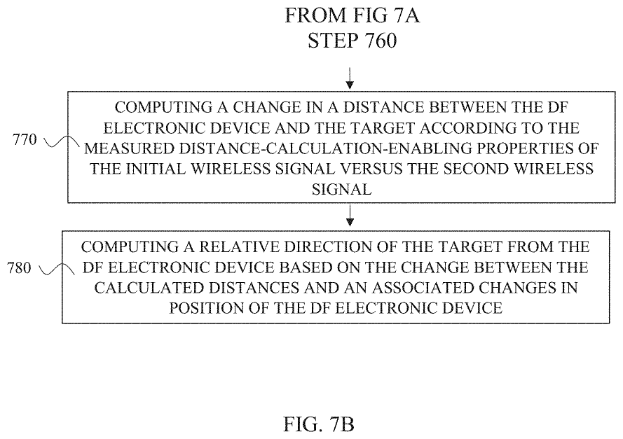

FIGS. 7A and 7B, taken together, shows a method for determining a relative location of a Target from the heading of a DF electronic device, according to an exemplary embodiment of the invention.

Step 700 discloses exchanging wireless signals between the DF electronic device and the Target in an initial position of the DF electronic device. The wireless signals comprise one or more signals. In some cases, the wireless signals are exchanged for a predefined period of time, for example 20 milli seconds.

Step 710 discloses measuring distance-calculation-enabling properties of at least one wireless signal exchanged between the DF electronic device and the Target in an initial position of the DF electronic device.

Step 720 discloses computing a distance estimation between the DF electronic device to the Target based on said distance-calculation-enabling properties in an initial position of the DF electronic device.

Step 730 discloses exchanging second wireless signals between the DF electronic device and the Target in at least one additional position of the DF electronic device.

Step 740 discloses measuring distance-calculation-enabling properties of at least one wireless signal exchanged between the DF electronic device and the Target in at least one additional position of the DF electronic device.

Step 750 discloses computing a distance estimation between the DF electronic device to the Target based on said distance-calculation-enabling properties in at least one additional position of the DF electronic device.

Step 760 discloses measuring the movement of the DF electronic device from the initial position to the at least one additional position in regard to the DF electronic device's heading. The movement measurement may be performed by a sensor of the DF electronic device. In some other cases, the movement of the DF electronic device is predetermined and provided to a user of the DF electronic device, for example in the form of text displayed on a display of the DF electronic device or audio commands outputted via a speaker of the DF electronic device. This way, the movement is not measured, but dictated by a computerized application operating at the DF electronic device. Difference in the distance measured by the DF electronic device indicates that the user indeed moved the DF electronic device.

Step 770 discloses computing a change in a distance between the DF electronic device and the Target according to the measured distance-calculation-enabling properties of the wireless signal at the initial position versus the wireless signal at the second position.

Step 780 discloses computing a relative direction of the Target from the DF electronic device based on the change between the calculated distances and an associated changes in position of the DF electronic device.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the invention not be limited to the particular embodiments described herein.

1. A direction-finding (DF) electronic device configured to compute a relative direction to at least one Target, the DF electronic device comprising:
a single antenna configured to exchange wireless signals with the Target;
a sensor module for sensing movement of the antenna;
a processor configured to perform instructions, said instructions comprising
in an initial position of the DF electronic device, measuring distance-calculation-enabling properties of the wireless signals exchanged between the DF electronic device and the Target, and computing an initial distance estimation between the DF electronic device to the Target based on said distance-calculation-enabling properties,
in at least one additional position of the DF electronic device, measuring distance-calculation-enabling properties of the wireless signals exchanged between the DF electronic device and the Target, and computing a distance estimation between the DF electronic device to the Target for the additional position based on said distance-calculation-enabling properties,
measuring the movement of the DF electronic device from the initial position to the at least one additional position in regard to the DF electronic device's heading,
computing a change in a distance between the DF electronic device and the Target according to the measured distance-calculation-enabling properties of the initial wireless signal versus the wireless signals, and
computing a relative direction of the Target from the DF electronic device's heading based on a change between the calculated distances and an associated changes in position of the DF electronic device.

2. The direction-finding electronic device of claim 1, wherein the single antenna is an omni-directional antenna.

3. The direction-finding electronic device of claim 1, wherein the single antenna is a directional antenna.

4. The direction-finding electronic device of claim 1, further comprising an indicator for indicating the relative direction of the Target.

5. The direction-finding electronic device of claim 4, wherein the indication is computed relative to the heading of the DF electronic device.

6. The direction-finding electronic device of claim 4, wherein the indication is selected from “forward”, “rearward”, “right”, “left” and a combination thereof.

7. The direction-finding electronic device of claim 4, wherein the indication is provided in the form selected from display, audio, illumination and a combination thereof.

8. The direction-finding electronic device of claim 1, wherein the instructions comprise generating a message to a user of the DF electronic device to move the DF electronic device.

9. The direction-finding electronic device of claim 1, wherein the instructions comprise generating a movement indication for indicating to a user of the DF electronic device a feedback on the required movement of the DF electronic device.

10. The direction-finding electronic device of claim 1, wherein the instructions comprise generating a movement indication for indicating to a user of the DF electronic device a stage of the movement of the DF electronic device.

11. The direction-finding electronic device of claim 1, wherein the instructions comprise generating a movement indication for indicating to a user of the DF electronic device a time left to complete a movement of the DF electronic device.

12. The direction-finding electronic device of claim 1, wherein the movement comprises a horizontal movement component.

13. The direction-finding electronic device of claim 1, wherein the DF electronic device is integrated in a smartphone.

14. The direction-finding electronic device of claim 1, wherein the DF electronic device is integrated in a wearable electronic device.

15. The direction-finding electronic device of claim 1, wherein the distance-calculation-enabling properties comprise time-of-flight properties.

16. A direction-finding (DF) electronic device configured to compute a relative direction to at least one Target, the DF electronic device comprising:
a single antenna configured to exchange wireless signals with the Target;
an output module for outputting messages to a user of the DF electronic device, the messages include guidance on how to move the DF electronic device; and
a processor configured to perform instructions, said instructions comprising
in an initial position of the DF electronic device, measuring distance-calculation-enabling properties of the wireless signals exchanged between the DF electronic device and the Target, and computing an initial distance estimation between the DF electronic device to the Target based on said distance-calculation-enabling properties,
outputting an instruction to move the DF electronic device to an additional position relative to the initial position and to the DF device heading,
receiving an indication that the DF electronic device is in the additional position,
in at least one additional position of the DF electronic device, measuring distance-calculation-enabling properties of the wireless signals exchanged between the DF electronic device and the Target, and computing a distance estimation between the DF electronic device to the Target for the additional position based on said distance-calculation-enabling properties,
computing a change in a distance between the DF electronic device and the Target according to the measured distance-calculation-enabling properties of the wireless signals exchanged in the initial position versus the wireless signals exchanged in the additional position, and
computing a relative direction of the Target from the DF electronic device based on a change between the calculated distances and an associated changes in position of the DF electronic device.

17. The direction-finding electronic device of claim 16, wherein the single antenna is an omni-directional antenna.

18. The direction-finding electronic device of claim 16, wherein the single antenna is a directional antenna.

19. The direction-finding electronic device of claim 16, further comprising an indicator for indicating the relative direction of the Target.

20. The direction-finding electronic device of claim 16, wherein the movement comprises a horizontal movement component.

21. The direction-finding electronic device of claim 16, wherein the DF electronic device is integrated in a smartphone.

22. The direction-finding electronic device of claim 16, wherein the DF electronic device is integrated in a wearable electronic device.

23. The direction-finding electronic device of claim 16, wherein the distance-calculation-enabling properties comprise time-of-flight properties.

24. A method for computing a relative direction from a DF electronic device to at least one Target, the method comprising:
in an initial position of the DF electronic device, measuring distance-calculation-enabling properties of wireless signal exchanged between the DF electronic device and the Target, and computing an initial distance estimation between the DF electronic device to the Target based on said distance-calculation-enabling properties;
in at least one additional position of the DF electronic device, measuring distance-calculation-enabling properties of the wireless signal exchanged between the DF electronic device and the Target, and computing a distance estimation between the DF electronic device to the Target for the additional position based on said distance-calculation-enabling properties;
measuring the movement of the DF electronic device from the initial position to the at least one additional position in regard to the DF electronic device's heading;
computing a change in a distance between the DF electronic device and the Target according to the measured distance-calculation-enabling properties of the initial wireless signal versus the wireless signal; and
computing a relative direction of the Target from the DF electronic device's heading based on a change between the calculated distances and an associated changes in position of the DF electronic device.

25. The method of claim 24, wherein the single antenna is an omni-directional antenna.

26. The method of claim 24, wherein the single antenna is a directional antenna.

27. The method of claim 24, further comprising outputting an indication for indicating the relative direction of the Target.

28. The method of claim 24, wherein the movement comprises a horizontal movement component.

29. The direction-finding electronic device of claim 24, wherein the DF electronic device is integrated in a smartphone.

30. The direction-finding electronic device of claim 24, wherein the DF electronic device is integrated in a wearable electronic device.

31. The direction-finding electronic device of claim 24, wherein the distance-calculation-enabling properties comprise time-of-flight properties.
